(19) United States
(12) Patent Application Publication
(10) Pub. No.: US 2009/0291239 A1
(43) Pub. Date: Nov. 26, 2009

(54) HIGH STRENGTH HOLLOW BOARD

(76) Inventor: SHUI-AN HUANG, An-Pin District (TW)

Correspondence Address: J.C. Patents, Suite 250, 4 Venture, Irvine, CA, 92618, US

(21) Appl. No.: 12/126,214

(22) Filed: May 23, 2008

(51) Int. Cl. B32B 3/20

(52) U.S. Cl. 428/34.1

(57) ABSTRACT

A high strength hollow board includes two plastic sheets and plural plastic bars fixed between the two plastic sheets. The plastic bars are elongate flat and erect bars successively bent into a series of S-shaped curves, able to evenly disperse a large external force borne by the hollow board and bear a horizontal bending force of the hollow board to prevent the hollow board from causing breakage by bending. Further, the two plastic sheets have their opposite inner sides respectively fixed with lots of lengthwise projecting bars for strengthening their pressure resistant and bending tensile force and producing refraction action, having effects of sound insulation, heat prevention and weakening of light.

### BACKGROUND OF THE INVENTION

1. Field of the Invention

This invention relates to a high strength hollow board, particularly to one formed by having lots of elongate plastic bars bent into a series of S-shaped curves and vertically fixed between two plastic sheets, able to evenly disperse a large external force borne by the hollow board for preventing the hollow board from being broken by bending.

2. Description of the Prior Art

A conventional hollow board formed integrally by injection includes two parallel plastic sheets 1, 2 and lots of plastic bars 7 vertically combined between the two parallel plastic sheets 1, 2. The plastic bars 7 are elongate, flat and erect bars respectively extended into a straight line for reinforcing the two parallel plastic sheets 1, 2 bear external pressure; therefore, the conventional hollow boards can be widely applied to lighting shades, sun sheds, French windows, partition plates and advertising hoardings.

However, the conventional hollow board is formed by having plural straight plastic bars 7 arranged spaced apart equidistantly to be fixed between the two parallel plastic sheets 1, 2, thus insufficient in pressure resisting force and unable to resist pressure vertically and horizontally. Further, when the conventional hollow board needs to be bent for an angle, as shown in FIG. 10, the two parallel plastic sheets 1, 2 between every two plastic bars 7 are likely to cause bending dents and even may result in breakage to spoil integrity of the hollow board. In addition, when the hollow board carries out lighting, strong sunlight will directly irradiate through the hollow board to irritate a person's eyes.

### SUMMARY OF THE INVENTION

The objective of the invention is to offer a high strength hollow board formed integrally of plastic by injection and including two plastic sheets and a plurality of plastic bars fixed between the two plastic sheets. The plastic bars are elongate flat and erect bars successively bent into a series of S-shaped curves and able to reinforce the whole structure of the hollow board for enhancing its vertical and horizontal pressure-resisting force and also evenly disperse a large external force borne by the hollow board. By so designing, the hollow board of this invention can strengthen its bending tensile force to bear a horizontal bending force, thus avoiding causing breakage by bending.

Further, the two plastic sheets have their opposite inner sides respectively fixed thereon with a plurality of straight and lengthwise projecting bars for elevating the pressure resistant and bending tensile force of the hollow board, and by refraction of the projecting bars, the hollow board can convert strong sunlight into gentle light and has effects of sound insulation, heat prevention and weakening of light. The projecting bars can be formed into a triangular shape or a semi-circular shape.

Furthermore, each original plastic bar has one side connected with a reinforcing bar diagonally fixed on one side of the original plastic bar and forms a triangle with the original plastic bar for enhancing the pressure resistant and bending tensile force of the hollow board, and by refraction of the reinforcing bars, strong sunlight can be converted into gentle light.

In addition, two reinforcing bars can be respectively connected with the opposite sides of each original plastic bar. The two reinforcing bars are respectively and diagonally fixed with original plastic bar to form an arrowhead-shaped structure with the original plastic bar, thus elevating the pressure resistant and bending tensile force of the hollow board and, by refraction of the reinforcing bars, completely converting strong sunlight into gentle light.

### BRIEF DESCRIPTION OF DRAWINGS

This invention will be better understood by referring to the accompanying drawings, wherein:

FIG. 1 is an exploded perspective view of a first preferred embodiment of a high strength hollow board in the present invention;

FIG. 2 is an upper view of the first preferred embodiment of the plastic bars of the high strength hollow board in the present invention;

FIG. 3 is a cross-sectional view of the first preferred embodiment of the high-strength hollow board in the present invention;

FIG. 4 is an exploded perspective view of the first preferred embodiment of two plastic sheets fixed thereon with plural projecting bars in the present invention;

FIG. 5 is an upper view of the first preferred embodiment of the plural projecting bars additionally fixed on the plastic sheet in the present invention;

FIG. 6 is an exploded perspective view of a second preferred embodiment of a high-strength hollow board in the present invention;

FIG. 7 is a side cross-sectional view of the second preferred embodiment of the high strength hollow board in the present invention;

FIG. 8 is a side cross-sectional view of a third preferred embodiment of a high strength hollow board in the present invention;

FIG. 9 is a perspective view of a conventional hollow board; and

FIG. 10 is a side cross-sectional view of the conventional hollow board in bent condition.

### DETAILED DESCRIPTION OF THE PREFERRED EMBODIMENT

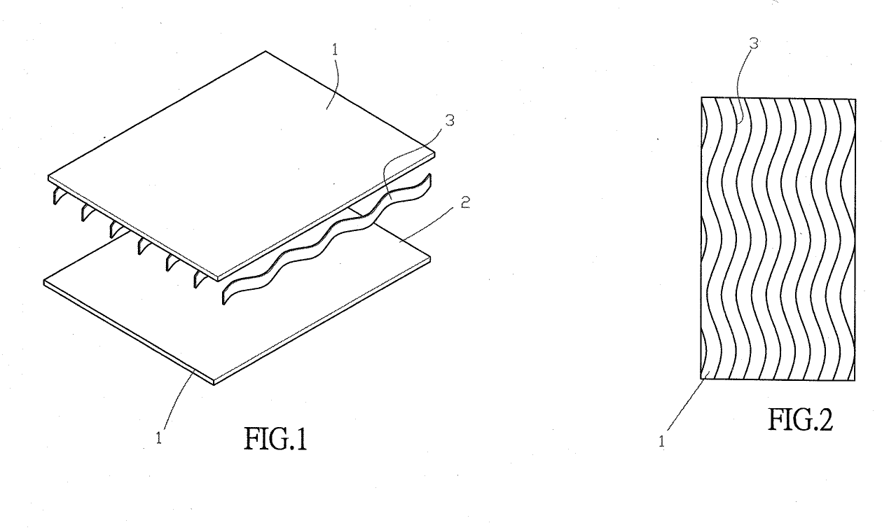

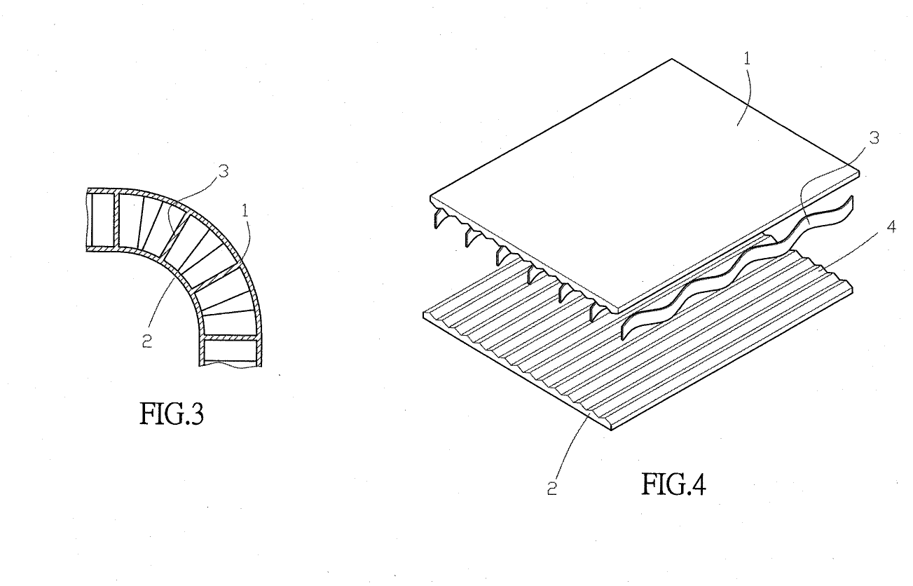

A first preferred embodiment of a high strength hollow board formed integrally of plastic by injection in the present invention, as shown in FIGS. 1 and 2, includes two plastic sheets 1, 2 and lots of plastic bars 3 vertically fixed between the two plastic sheets 1, 2. The plastic bars 3 are elongate flat and erect bars successively bent into a series of S-shaped curves to enable the whole structure of the hollow board to strengthen its pressure resistant and bending tensile force, letting the hollow board able to bear a large external force and a horizontal bending force so as to prevent breakage caused by bending, as shown in FIG. 3.

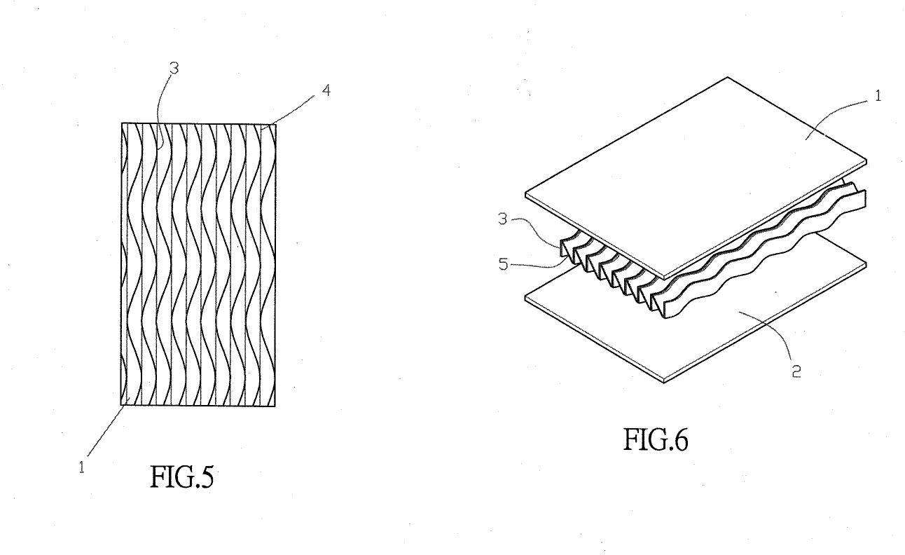

Referring to FIGS. 4 and 5, the two plastic sheets 1, 2 have their corresponding inner sides respectively fixed thereon with lots of straight and lengthwise projecting bars 4 with a triangular shape or a semi-circular shape for enhancing the pressure resistant and bending tensile force of the hollow board, and by refraction of the projecting bars 4, strong sunlight can be converted into gentle light. Thus, the hollow board of this invention can improve the drawback of the conventional hollow board that the sunlight directly irradiates through the two plastic sheets 1, 2 to irritate a person's eyes, and also has effects of sound insulation, heat prevention and weakening of light.

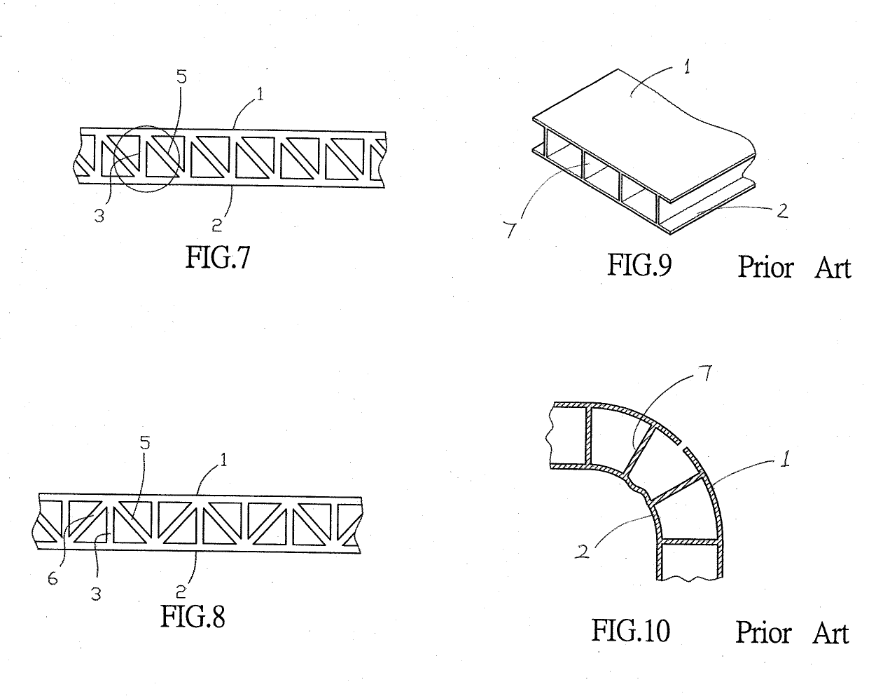

A second preferred embodiment of a high strength hollow board in the present invention, as shown in FIG. 7, is to have a reinforcing plastic bar 5 diagonally connected with one side of each original plastic bar 3 to form a triangle with the original plastic bar 3. Thus, the hollow board can strengthen its pressure resistant and bending tensile force, and therein forcing bars 5 diagonally fixed between the two plastic sheets 1, 2 adds a partition layer and oblique reflection action to the hollow board, able to completely convert the strong sunlight into mild light for protecting a person's eyesight and having effects of sound insulation, heat prevention and weakening of light.

A third preferred embodiment of a high strength hollow board in the present invention, as shown in FIG. 8, is to have two reinforcing plastic bars 5, 6 respectively and diagonally connected with the opposite sides of each original plastic bar 3 to form an arrowhead-shape structure with the original plastic bar 3 so as to reinforce pressure resisting and bending tensile force of the hollow board. By so designing, partition layers and oblique reflection are added to the hollow board, able to completely convert strong sunlight into mild light and having effects of sound insulation, heat prevention and light weakening.

While the preferred embodiments of the invention have been described above, it will be recognized and understood that various modifications may be made therein and the appended claims are intended to cover all such modifications that may fall within the spirit and scope of the invention.

I claim:

1. A high strength hollow board comprising two plastic sheets and a plurality of plastic bars vertically fixed between said two plastic sheets; and
characterized by said plastic bars being elongate flat and erect bars formed with a series of S-shaped curves.

2. The high strength hollow board as claimed in claim 1, wherein said two plastic sheets have their opposite inner sides respectively disposed with lots of straight and lengthwise projecting bars with a triangular shape or a semi-circular shape.

3. A high strength hollow board comprising two plastic sheets and a plurality of plastic bars vertically fixed between said two plastic sheets; and
characterized by said plastic bars being elongate flat and erect bars bent successively, each said plastic bar having one side connected with a reinforcing plastic bar, said reinforcing plastic bar diagonally connected with one side of said plastic bar and forming a triangle with said plastic bar.

4. A high strength hollow board comprising two plastic sheets and lots of plastic bars vertically combined between said two plastic sheets; and
characterized by said plastic bars being elongate flat and erect bars bent in series, each said plastic bar having its opposite sides respectively connected with a reinforcing bar, said reinforcing bars respectively and diagonally fixed at opposite sides of said plastic bar and forming an arrowhead-shaded structure with said plastic bar.
